(19) United States
(12) Patent Application Publication
(10) Pub. No.: US 2006/0282026 A1
(43) Pub. Date: Dec. 14, 2006

(54) Method and apparatus for controlling massage using pressure inducing elements

(76) Inventors: Harry Glen, Jupiter, FL (US); Christopher Paul Zura, Juno Beach, FL (US)

Correspondence Address: Harry Glen, 2200 SE Ranch Road, Jupiter, FL, 33478, US

(21) Appl. No.: 11/441,739

(22) Filed: May 27, 2006

Related U.S. Application Data
(60) Provisional application No. 60/688,768, filed on Jun. 8, 2005.

(51) Int. Cl. A61H 23/00

(52) U.S. Cl. 601/98; 601/111; 601/103

(57) ABSTRACT

This application covers the method and control apparatus for controlling the massage of a long fiber muscle or group of muscles using a plurality or array of pressure inducing elements. The apparatus is a microprocessor based controller that provides an interface for the user to interactively locate and target areas of affected muscle tissue to specifically provide a beneficial effect which alleviates pain or provides other therapeutic results. Based on the principles and disciplines of reflexology, the controller apparatus also contains certain logic to precisely control the timing and pattern of the random command signals for the activation of pressure inducing elements in a related massage apparatus.

### RELATED APPLICATIONS

This is a U.S. utility patent application for the method and control apparatus as an improvement to the massage apparatus described in U.S. Pat. No. 6,146,342 and previously filed under the provisional application No. 60/688,768.

### FIELD OF THE INVENTION

The present invention relates generally to the method and control apparatus for controlling the massage of a long fiber muscle or group of muscles using random timing and pattern of the plurality or array of pressure inducing elements.

### BACKGROUND OF THE INVENTION

The present invention relates to the method and control apparatus for controlling massage using random timing and pattern of the plurality or array of pressure inducing elements in such apparatus as in the related U.S. Pat. No. 6,146,342 issued to Harry Glen on Nov. 14, 2000. While Glen states a microprocessor, if provided, can be programmed to issue random command signals, the present invention is a microprocessor based controller apparatus and method to issue the required random command signals as put forth in the applicant's original invention.

Massage devices for muscle massage and muscle relaxation are known. Such devices may employ arrays of powered plungers arranged to strike the skin of a person being massaged such that impacts of the plungers collectively provide a beneficial effect which alleviates pain or provides other therapeutic results.

U.S. Pat. No. 4,779,615, issued to Richard K. Frazier on Oct. 25, 1988, U.S. Pat. No. 4,788,968, issued to German E. Rudashevsky et al. on Dec. 6, 1988, U.S. Pat. No. 5,245,989, issued to Rosalie Simon on Sep. 21, 1993, are illustrative. In each case of the prior art cited above, reciprocating plungers are controlled according to a scheme which affects one or more characteristics of plunger action. For example, Rudashevsky et al. controls frequency of plunger operation within a range of 0 to 250 Hz by connection to an AC electrical circuit. Rudashevsky et al. is concerned with design of individual plunger actuators, and is silent regarding an overall pattern of plunger action. By contrast, the present invention produces random patterns for an array or plurality of actuators to specifically provide a beneficial effect which alleviates pain or provides other therapeutic results.

Frazier controls a plurality of plungers in a pattern which correlates to musical characteristics, these characteristics being analyzed by a microprocessor which then issues control signals actuating individual plungers accordingly to influence frequency, amplitude, and beat. This is different from actuating individual plungers randomly, as practiced in the present invention. In fact, predictable nature of musical cadences may act to defeat randomness in that the body may come to anticipate plunger action to a degree and thus reduce any possible therapeutic results.

Simon individually controls plungers for time duration, frequency, and pressure. Unlike the present invention, there is no provision for random actuation of plungers.

In U.S. Pat. No. 5,279,284, issued to Gordon W. Fenn on Jan. 18, 1994, plungers are activated according to specific patterns, such as progressive actuation of adjacent rows, although adjacent plungers may be asynchronous due to variable tolerances of timing components. However, the device of Fenn is a rigid, hand held device, rather than using an array or plurality of actuators covering the whole area of application.

None of the above inventions and patents, taken either singly or in combination, is seen to describe the instant invention as claimed.

### SUMMARY OF THE INVENTION

In view of the foregoing and other considerations, the present invention relates to the method and control apparatus for controlling the massage of a long fiber muscle or group of muscles by using random timing and pattern to activate an array of pressure inducing elements in a massage apparatus, herein referenced as “Massage Apparatus”. The present invention describes a microprocessor based controller apparatus to generate the randomized electronic command signals provided to the circuitry driving the pressure inducing elements in the Massage Apparatus. Further, the present invention describes an interface for the user to interactively locate and target areas of affected muscle to specifically provide a beneficial effect which alleviates pain or provides other therapeutic results.

The present inventor has discovered that a muscle will tense in anticipation of a stimulus, such as that produced by impact of a plunger against the skin. If, however, location and timing of impact of specific plungers cannot be predetermined with regularity, then collective impacts of many plungers will act to relax a muscle rather than to cause contraction of that muscle. The Golgi tendon organ is known for its ability to detect tension applied to the tendon by muscle contraction. When tension on the muscle and tendon becomes extreme, inhibitory effect from the tendon organ can result in sudden relaxation of the entire muscle. This effect is referred to within the discipline of reflexology as the lengthening reaction. Stated another way, the present applicant believes that the Golgi tendon organ causes sudden relaxation of the entire muscle when the muscle area is subjected to random impacts.

To best achieve these effects, the present invention provides significant enhanced elements and improvements over the simple controller embodiment in the related U.S. Pat. No. 6,146,342. The present invention apparatus, herein referenced as “Controller”, features an enhanced user interface allowing the user to interactively target and isolate massage areas for maximizing the beneficial effects which alleviate pain or provide other therapeutic results. The Controller also features a microprocessor based design with some of the invention embodiments implemented as software, herein referenced as “Software”, and stored in nonvolatile memory. Based on the principles and disciplines of reflexology, the Controller Software contains certain logic algorithms to precisely control the timing and pattern of the random command signals related to the activation of pressure inducing elements in a Massage Apparatus. Some of the same embodiments are also implemented in the accompanying simulation software, herein referenced as “Simulator”, to fully illustrate through computer animation the interactive user interface and the various activation patterns and timing generated by the present apparatus.

While the present invention allows highly controllable stimuli through microprocessor based control, other medical applications besides the treatment of muscle pathology are apparent including the movement of lymphatic tissue and other circulatory fluids that can lead to the prevention of venous stasis ulcers (bed sores) and the promotion of better venous return.

Accordingly, it is one object of the invention to provide a microprocessor based apparatus to provide the random control signals to the Massage Apparatus to control a plurality or array of pressure inducing elements.

It is another object of the invention to provide random control signals so that location of subsequent impacts of the pressure inducing elements cannot be anticipated.

In accordance with another aspect of the invention, it is another object of the invention to provide a user interface that allows the user to interactively locate and target massage areas for maximizing the beneficial effects.

An additional object of the invention is to provide control over all other features including but not limited to the heating element within the Massage Apparatus.

Yet another object of the invention is to provide control over the general power to the Massage Apparatus.

These and other objects of the present invention will become readily apparent upon further review of the following specification and drawings.

### BRIEF DESCRIPTION OF THE DRAWINGS

The foregoing and other features and aspects of the subject invention will be best understood with reference to a detailed description of a specific embodiment of the invention, which follows, when read in conjunction with the accompanying drawings, in which:

FIG. 1 is a functional block diagram of the invention apparatus, or Controller, including the Interface and CPU Modules along with the schematic of primary communication linkages between the modules and a Massage Apparatus in accordance with one embodiment of the invention;

FIG. 2 is a detailed view of the interactive user Interface Panel related to the Interface Module in accordance with one embodiment of the invention in FIG. 1;

FIG. 3 is a view of an arrangement of pressure inducing elements included in one embodiment of the Massage Apparatus in FIG. 1;

FIG. 4 is a diagram of the same arrangement of pressure inducing elements in FIG. 3;

FIG. 5 is a diagram of the duty cycle related to the actuation of pressure inducing elements controlled by the Controller in FIG. 1;

FIG. 6 is a diagram illustrating the operation of the Super Deluxe Pattern related to the actuation of pressure inducing elements controlled by the Controller in accordance with one embodiment of the invention;

FIG. 7 is a diagram illustrating the operation of the Rolling Pattern related to the actuation of pressure inducing elements controlled by the Controller in accordance with another embodiment of the invention;

FIG. 8 is a diagram illustrating another variation of the operation of the Rolling Pattern related to FIG. 7;

FIG. 9 is a diagram illustrating the operation of the Targeted Pattern related to the actuation of pressure inducing elements controlled by the Controller in accordance with yet another embodiment of the invention;

FIG. 10 is a diagram illustrating the operation of the Symmetrical Pattern related to the actuation of pressure inducing elements controlled by the Controller in accordance with still yet another embodiment of the invention;

FIG. 11 is a diagram illustrating the calculation of symmetrical or mirrored elements in FIG. 10.

### DETAILED DESCRIPTION OF SPECIFIC EMBODIMENTS OF THE INVENTION

The present invention makes use of microprocessor technology to provide the random control signals to control a plurality or array of pressure inducing elements such as is present in a Massage Apparatus. It is the intent of the present invention to provide random control signals so that the location of subsequent impacts of the pressure inducing elements cannot be anticipated as according to the principles and disciplines of reflexology. The present invention also provides an interface for the user to control any or all of the various functions and operational parameters of a Massage Apparatus including the ability to interactively locate and target areas of affected muscle tissue to specifically provide a beneficial effect which alleviates pain or provides other therapeutic results. The specific implementation of the electronic circuitry needed to implement the functions and functionality described herein, particularly that of the apparatus, are not critical for the purposes of the present invention.

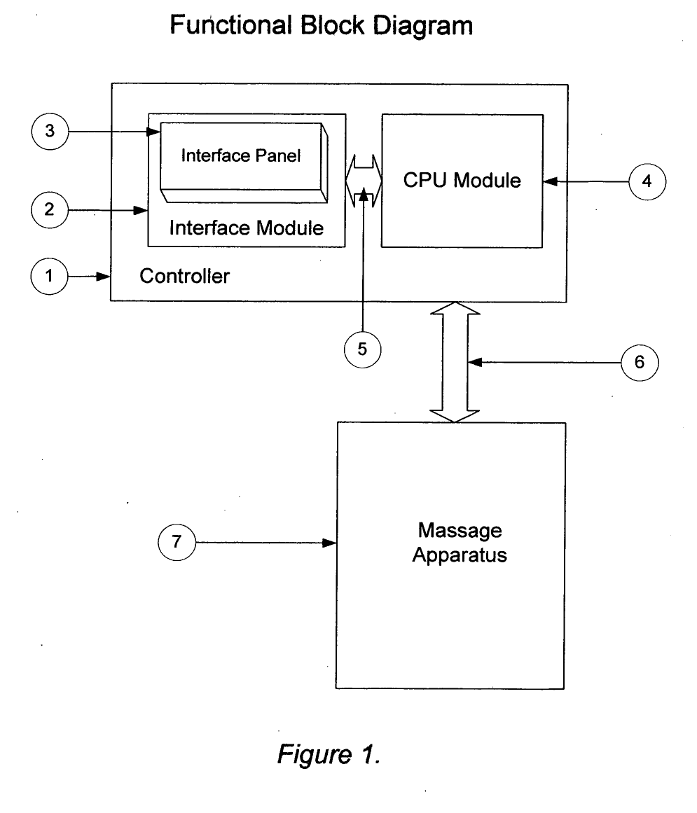

In accordance with one embodiment of the invention, FIG. 1 is a functional block diagram of the invention apparatus, or Controller 1. The presently disclosed Controller embodiment consists of two primary components: a CPU module 4 and an Interface Module 2 along with the primary communication linkage 5 between the modules. It is intended that the term “Module” as used herein shall encompass any arrangement of the various electronic elements necessary for performing the intended functions described herein. Another communication linkage 6, enables the primary communication between the Controller 1 and a Massage Apparatus 7 to allow the Controller to provide the random command signals along with any or all other control signals as required by the Massage Apparatus including but not limited to controlling the heat element and general power of the Massage Apparatus.

In one embodiment, the CPU Module 4 and the Interface Module 2 are disposed upon a printed circuit board. The CPU Module comprises a microprocessor, random-access memory (RAM), flash read-only memory (flash ROM), a system clock, and associated communications. Software for controlling operation of the microprocessor is preferably stored as firmware in the flash ROM, as will be hereinafter described. It is believed that the design of the CPU Module to perform the functions described herein would be a matter of routine engineering to persons of ordinary skill in the art, and the details of implementation of the CPU Module will be evident to those of ordinary skill in the art based upon the functional description provided herein.

As noted above, it is believed that the specific implementation of the electronic circuitry needed to implement the functions and functionality described herein, particularly that of Controller 1, are not critical for the purposes of the present invention, and that the design and implementation of such electronics would be a matter of routine engineering to a person of ordinary skill in the art. Accordingly, specific implementation details about the electronics in the disclosed embodiment shall not be further described herein.

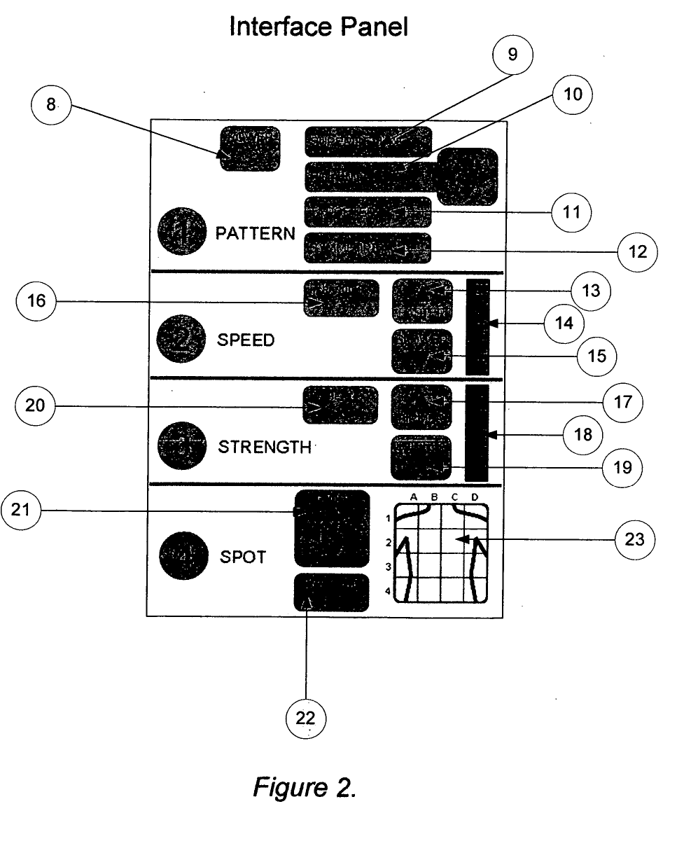

FIG. 2 is a detailed view of the Interface Panel 3 which is part of Interface Module 2 in accordance with one embodiment of the invention in FIG. 1. The Interface Panel allows the user to provide various inputs to Interface Module while also providing status output related to the operation of the Massage Apparatus. In one embodiment, the Interface Module and Interface Panel can consist of a membrane keypad and series of status LEDs directly under control of the CPU Module 4 through a wired communication linkage 5. In an alternate embodiment, the Interface Module can consist of a complete PC with a touch screen LCD display and wireless communication link running an operation system and software application that provides all of the same functionality as described above. Those of ordinary skill in the art having the benefit of the present disclosure will appreciate, however, that various forms and combinations of components such as described herein can be employed in additional embodiments to provide the interactive user input, status display and computation requirements of the Interface Module and CPU Module.

As will be hereinafter described in further detail, in accordance with one aspect of the user interface, the invention may be responsive to user interaction. The Interface Panel in FIG. 2 provides an interface for the user to control any or all of the various functions and operational parameters of a Massage Apparatus. This is believed to be a particularly advantageous aspect of the invention, since it enables the user to initiate the massage action to interactively locate and target areas of affected muscle tissue to specifically provide a beneficial effect which alleviates pain or provides other therapeutic results.

Referring to FIG. 2, the Interface Panel contains user controls, or “buttons”, not necessarily in the literal sense, but comprising of presentation areas when the user can press, click, or perform some other action required to engage an intended response or view a status related to the user interface. In the presently disclosed embodiment of the invention, the Interface Panel contains a Power control 8 with indicator to allow the user to engage the power to the Massage Apparatus. The Heat control 20 with indicator allows the user to engage the heat element in the Massage Apparatus. The Pattern controls 9, 10, 11, and 12 allow the user to select the Super Deluxe, Rolling, Targeted or Symmetrical Pattern, respectively, as will be hereinafter described in further detail. The Speed controls 13 and 15 allow the user to increase or decrease the operating speed, respectively, while indicator 14 displays a bar graph indicating the current speed. The Random Speed control 16 with indicator allows the user to select truly randomized speed related to the timing of activation of the pressure inducing elements as will be hereinafter described in further detail. The Strength controls 17 and 19 allow the user to increase or decrease, respectively, the operating strength of impact of the pressure inducing elements as will be hereinafter described in further detail while indicator 18 displays a bar graph indicating the current strength. The Guided control 22 along with indicator and four directional controls allow the user to direct the location of Target and Symmetrical Patterns as will be hereinafter described in further detail. The Wandering provides the user with a randomized wandering feature for the Targeted and Symmetrical Patterns as will be hereinafter described in further detail. The Location control 23 provides real time display of the target area for the Targeted Pattern.

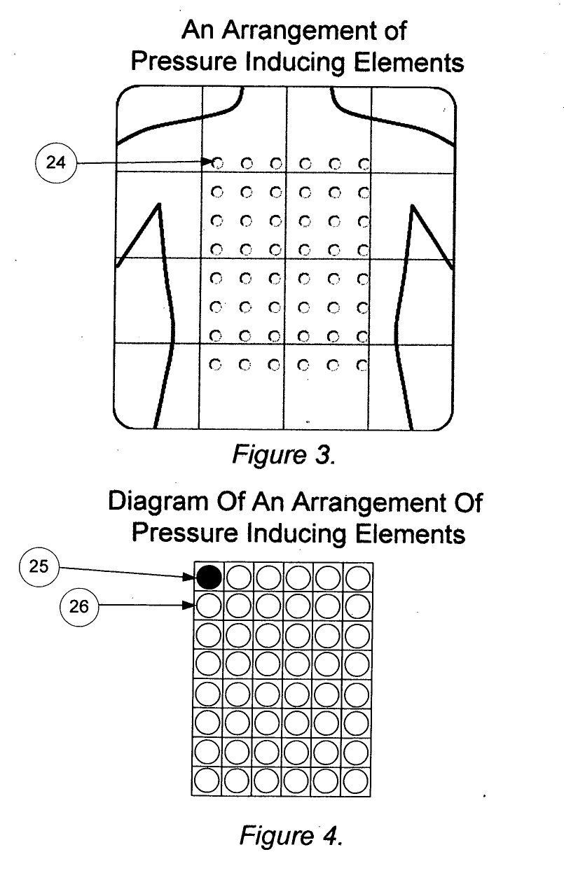

FIG. 3 is a view of an arrangement of pressure inducing elements as might be in the embodiment of a Massage Apparatus as in FIG. 1. In this example, a six by eight array of pressure inducing elements has been selected to effectively illustrate one possible embodiment of the invention, while the actual number of elements and their arrangement are immaterial to the present invention. FIG. 4 is diagram representing the same arrangement of pressure inducing elements while illustrating an activated element 25 and a deactivated element 26.

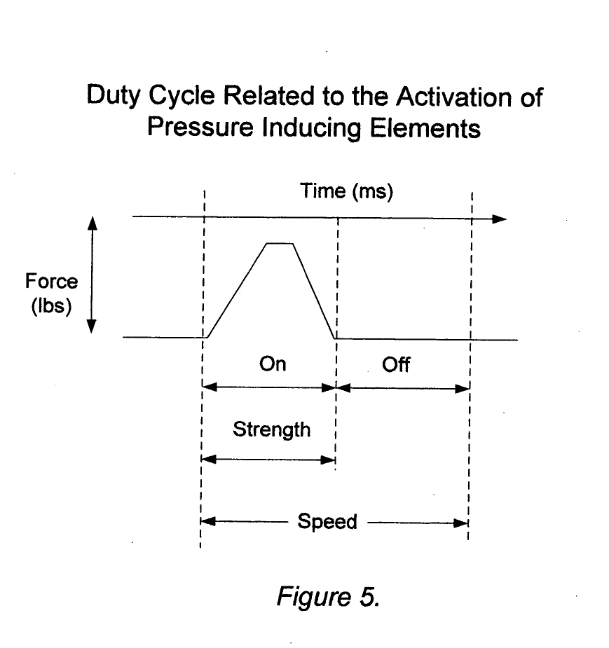

FIG. 5 is a diagram of the duty cycle related to the actuation of pressure inducing elements controlled by the Controller in one embodiment of the present invention. One duty cycle represents the time any element or group of elements is activated and then deactivated, or on and off, respectively, during normal operation. The diagram illustrates that the activation time represents the Strength or force of the activated element while the total time represents the Speed. In this embodiment, the user interface provides control over these two operating parameters in the following manner. The Strength controls 17 and 19 allow the user to increase or decrease the activation time, respectively, controlling the Strength or force of impact of the pressure inducing elements. The Speed controls 13 and 15 allow the user to increase or decrease the total cycle time, respectively, thus allowing the user to control the parameter called Speed. The Random Speed control 16 with indicator allows the user to select a truly randomized cycle time, calculated by a random number generator, to completely randomize the timing of activation of the pressure inducing elements.

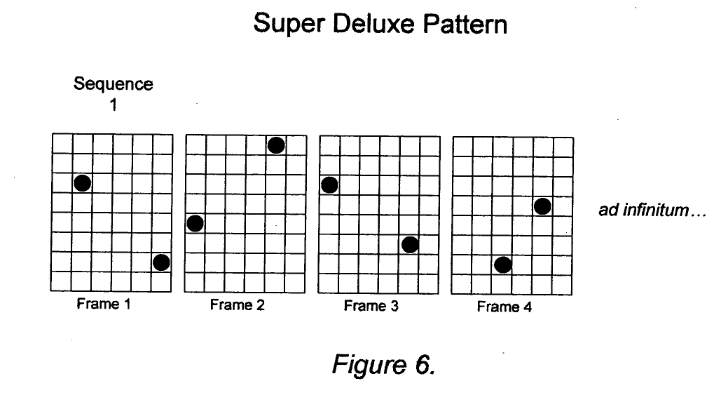

FIG. 6 is a diagram illustrating the operation of the activation pattern related to the Super Deluxe Pattern in accordance with one embodiment of the invention. In Sequence 1, the Frames 14 show part of a possible random pattern generated by the Controller. Since the pattern is truly randomized using a random number generator in the Software, the pattern shown is only representative of one possible pattern.

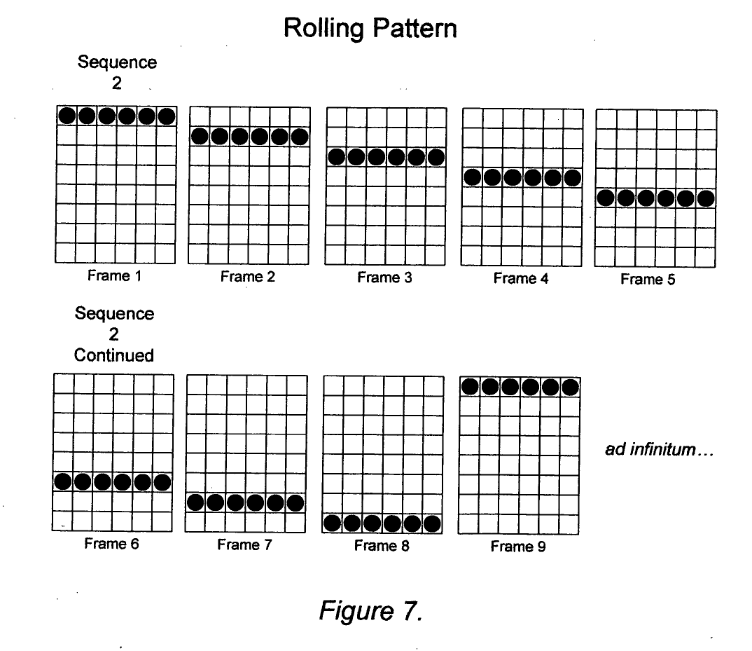

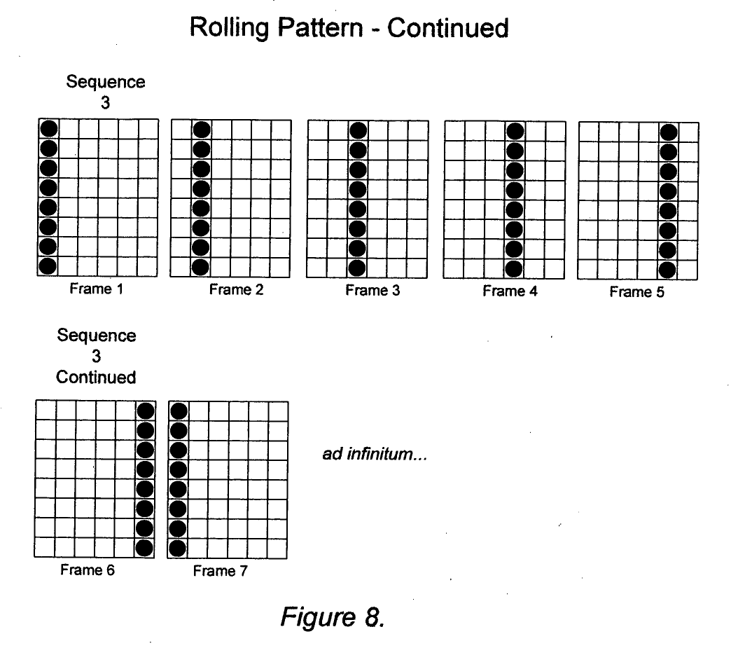

FIG. 7 and FIG. 8 are diagrams illustrating the operation of the activation pattern related to the Rolling Pattern in accordance with another embodiment of the invention. In the example of Sequence 2, the user has selected the down arrow using the Rolling controls. Frames 1-9 show the downward action until the last frame the sequence is repeated as in Frame 1. If the user had selected the up arrow, the frame order would be in the reverse. Likewise, Sequence 3 illustrates the use of the right arrow on the Rolling controls, where the reverse frame order represents the use of the left arrow.

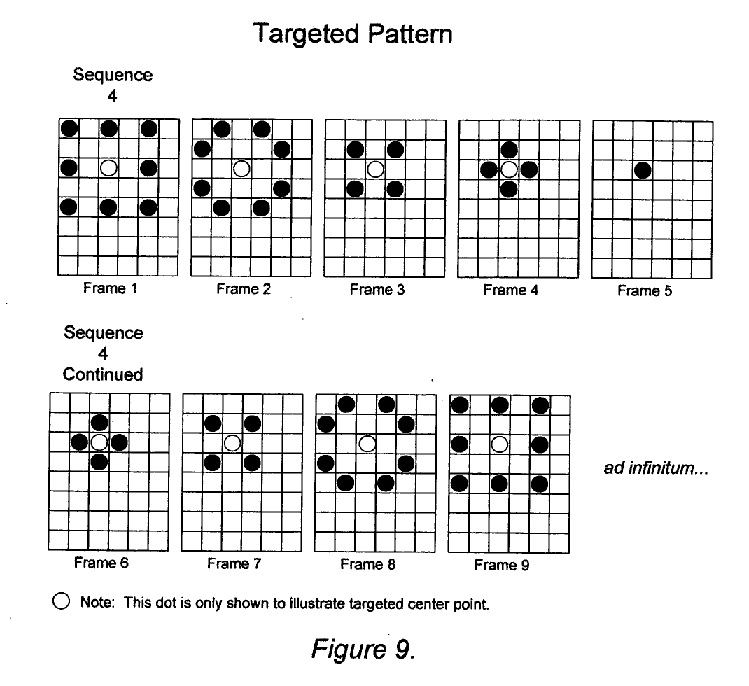

FIG. 9 is a diagram illustrating the operation of the activation pattern related to the Targeted Pattern in accordance with yet another embodiment of the invention. In the example of Sequence 4, a center point coordinate is selected by the user using the Guided controls or is randomly generated by a random number generator in the Wandering mode. In Sequence 4, the following frames illustrate the pattern of concentric circles that are formed within the matrix, moving inward until the targeted spot is pinpointed. Frame 1 forms the outer most circle around the center point while Frame 5 represents the striking of the targeted spot. The pattern is then reversed in Frames 6-9, with Frame 9 repeating the sequence as in Frame 1. Frame 9 marks the point at which a new center point would be calculated in the Wandering mode.

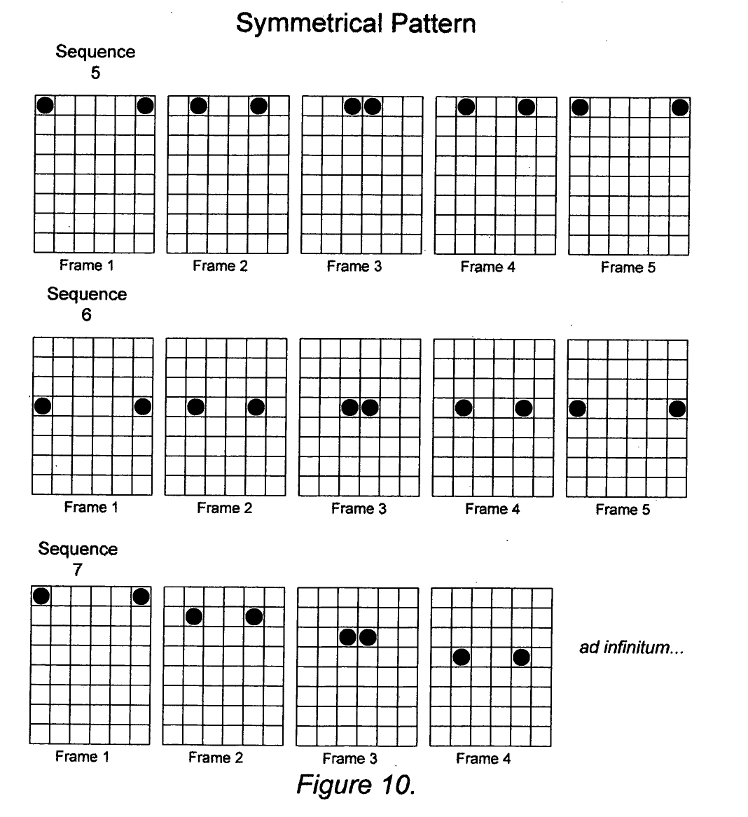

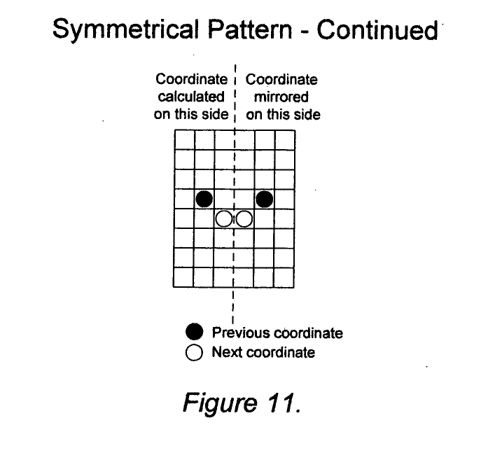

FIG. 10 illustrates the operation of the activation pattern related to the Symmetrical Pattern in accordance with still yet another embodiment of the invention. In the example of Sequence 5, the user has selected the upper most position using up/down arrows on the Guided controls. Frames 1-3 represent the symmetrical pattern moving from the outside into the center while Frames 4-5 reverse the pattern, where Frame 5 repeats the sequence as in Frame 1. Sequence 6 is similar to the previous, except the Consumer has selected a position near the center of the back using the Guided controls. Sequence 7 represents one possible Symmetrical Pattern in the Wandering mode. A coordinate is randomly calculated, adjacent to the previous coordinate, within half of the matrix and then mirrored onto the other half, as illustrated in FIG. 11.

Those of ordinary skill in the art will appreciate that in alternate embodiments, various combinations of patterns and timing are possible. Additionally, although the present disclosure speaks in terms of one or more possible discrete patterns with associated timing related with duty cycle, as the implementation requirements dictate, alternate embodiments are described herein primarily in functional terms and include all presently known such means and any means to be developed in the future.

In a presently preferred embodiment of the invention, the Controller is implemented as modular components, extolling the benefits of modularity where components can be swapped for compatibility, serviceability and upgradeability. Those of ordinary skill in the art having the benefit of the present disclosure can appreciate this modular approach to enable the level serviceability required to allow future product upgrades and enhancements.

As described above, the invention in part involves the use of computer-based electronic systems, of which many consumer and industrial grades and types are available. The programming necessary to implement the functionality described herein is believed to be within the capability of any competent programmer, and may be accomplished through the use of a program storage device readable by the processor that encodes a program of instructions executable by the processor for performing the operations described above. The program storage device may take the form of, e.g., a floppy disk; a CD-ROM; a memory device (e.g., RAM, ROM, EPROM, EEPROM, etc.); and other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The program storage device may be one that is directly readable by the processor, or it may be one that is unusable by the processor per se but that provides intermediate storage of the program of instructions. The program of instructions may be read directly from the program storage device by the processor; alternatively, the program of instructions may be temporarily or permanently stored in the program storage device and transmitted from it to the processor over one or more links, e.g., over a telephone connection (such as a modem connection, DSL, or ISDN line); over a cable-modem hookup; over the Internet; via radio or satellite transmission; etc., possibly with other program storage devices providing intermediate storage along the way. The precise forms of the program storage device and of the encoding of instructions are immaterial here.

Although specific embodiments of the invention have been described herein in some degree of detail, this has been done merely to illustrate various features and aspects of the present invention, and is not to be construed as limiting the scope of the invention as defined by the claims which follow. Those of ordinary skill in the art will appreciate that various substitutions, alterations, and/or modifications, including but not limited to those design variations and options that have been specifically noted herein, may be made to any of the embodiments of the invention disclosed herein without departing from the spirit and scope of the claims which follow.

What is claimed is:

1. A massage system, comprising of:
a massage apparatus for the massage of a long fiber muscle or group of muscles using a plurality or array of pressure inducing elements;
a controller apparatus consisting of an interface module coupled with a CPU module for controlling the said massage apparatus;
an interface panel coupled to said interface module for interactively capturing user input and providing visual, audible or other indicators of system operation;
wherein said controller apparatus is coupled to said massage apparatus through a communications linkage that transmits and/or receives at least one signal between both apparatuses to precisely control and activate of the plurality or array of pressure inducing elements along with other system functions.

2. A system in accordance with claim 1, wherein said controller apparatus generates at least one signal to activate the plurality or array of pressure inducing elements in said massage apparatus.

3. A system in accordance with claim 1, wherein said interface panel interactively captures user input for the purpose of controlling any or all operating parameters including but not limited to the pattern, speed, strength, or timing related to the activation of the plurality or array of pressure inducing elements.

4. A system in accordance with claim 1, wherein said interface panel interactively captures user input for the purpose of locating areas of massage using the plurality or array of pressure inducing elements.

5. A system in accordance with claim 1, wherein said controller apparatus generates at least one signal based on user interaction with said interface panel to activate the plurality or array of pressure inducing elements.

6. A system in accordance with claim 1, wherein said controller apparatus generates at least one signal based on any or all operating parameters including but not limited to the pattern, speed, strength, or timing related to the activation of the plurality or array of pressure inducing elements.

7. A system in accordance with claim 1, wherein said controller apparatus generates at least one signal to generate a random pattern related to the activation of the plurality or array of pressure inducing elements.

8. A system in accordance with claim 1, wherein said controller apparatus generates at least one signal to generate a rolling pattern related to the activation of the plurality or array of pressure inducing elements to simulate a rolling method of massage.

9. A system in accordance with claim 1, wherein said controller apparatus generates at least one signal to generate a targeted pattern related to the activation of the plurality or array of pressure inducing elements to simulate a targeted method of massage.

10. A system in accordance with claim 1, wherein said controller apparatus generates at least one signal to generate a symmetrical pattern related to the activation of the plurality or array of pressure inducing elements to simulate a symmetrical method of massage.

11. A system in accordance with claim 1, wherein said controller apparatus generates at least one signal to generate any pattern, currently known or unknown, related to the activation of the plurality or array of pressure inducing elements used for massage.
